(19) United States
(12) Patent Application Publication
(10) Pub. No.: US 2010/0235878 A1
(43) Pub. Date: Sep. 16, 2010

(54) METHOD AND SYSTEM FOR FILE DISTRIBUTION

(75) Inventors: Seh Eing LIM, Singapore (SG); Lai Yong Lau, Singapore (SG); Wong Hoo Sim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd., Singapore (SG)

(21) Appl. No.: 12/403,691

(22) Filed: Mar. 13, 2009

(51) Int. Cl. G06F 17/30; G06F 21/00; G06F 12/16

(52) U.S. Cl. 726/1; 707/E17.01; 711/114; 711/E12.001; 711/E12.103

(57) ABSTRACT

A method and system for file distribution, the system comprising: a first data storage device for distributing a content file by seeding the content file for downloading by another data storage device; a second data storage device configured for distributing the content file; a third data storage device configured for distributing the content file; and a data file comprising at least one data entry, a data entry in the data file being associated with the content file, the first data storage device being configured for pushing the data file to the second data storage device, the second data storage device being configured for initiating downloading of the content file if the data entry associated with the content file is present in the pushed data file and the content file is not stored at the second data storage device, and sharing downloaded data of the content file with the third data storage device by simultaneously uploading downloaded data of the content file to the third data storage device while downloading the content file from the first data storage device.

### FIELD OF INVENTION

The present invention relates to a method and system for file distribution, in particular, relating to file distribution in a network utilising peer-to-peer data distribution, and the like.

### BACKGROUND

Traditionally, file distribution from a server to a client terminal in a network would typically require a user at a client terminal to open a web page and click on a link to download a file to the client terminal. On clicking the link, the web browser on the client terminal would inform the server, i.e. a central computer hosting the web page and storing the file intended to be downloaded, to transfer a copy of the file to the client terminal. The file transfer would be handled by a protocol, for instance, FTP (File Transfer Protocol) or HTTP (HyperText Transfer Protocol). The file transfer speed is affected by a number of variables, including the type of protocol, the amount of traffic on the server and the number of other client terminals that are downloading the file. If the file is both large and popular, the bandwidth demands on the server would be great, and the download would be slow.

A solution to the problem of high bandwidth demands on the server in the traditional method of file distribution is to use Bittorrent. Bittorrent is a peer-to-peer file sharing protocol that is capable of utilizing the bandwidth of client terminals (or peers) to assist in the distribution of files. A distributor of a complete file acts as a seeder, which allows other peers to download the entire file or parts of the file from it. Each peer downloading the data of the file also uploads the downloaded data to other peers. The data of the file is downloaded in pieces. A peer may hold and share a different piece of the file with other peers. To download a file using Bittorrent, typically, a user must have on its client terminal a Bittorrent Client program and a torrent file associated with the actual file to be downloaded. The torrent file has a substantially smaller file size compared to its associated file. Downloading of the actual file begins when the torrent file is executed by the Bittorrent client program. Advantageously, the Bittorrent approach provides a significant reduction in the original distributor's hardware and bandwidth resource costs.

However, current usage of Bittorrent suffers from a few problems. One of which is a lack of anonymity. It is possible to obtain the Internet Protocol (IP) addresses of all current, and possibly previous, file sharing peers from a tracker, i.e. a server which assists in the communication between peers using the Bittorrent protocol, and this may expose users with insecure systems to attacks.

Also, peers often have little incentive to be seeders after the file has been completely downloaded, thus resulting in the lack of availability of the file for downloading, or worse, no availability for download. Typically, less popular or older files would have a lower availability for downloading. Furthermore, some seeders may willfully withhold a specific piece of the data and this would result in peers downloading all but the final piece from the seed and from each other.

In addition, for most of the time, if users wish to download a particular file, they have to search for the torrent file themselves. Searching for the torrent file can be quite a hassle. While there is an existing method called ‘Broadcatching’ providing automatic monitoring and downloading of digital content that has been made available over the Internet based on Really Simple Syndication (RSS) feeds, it has been criticized for enabling users to download and distribute copyrighted television show episodes as soon as they are released. Furthermore, ‘Broadcatching’ requires the user to have some technical know-how to activate and it requires the user's terminal to be switched on all the time in order to receive the downloaded content.

A need therefore exists to provide a method and system for file distribution that addresses at least one of the above-mentioned problems.

### SUMMARY

In accordance with one aspect of the present invention, there is provided a system for file distribution, the system comprising: a first data storage device for distributing a content file by seeding the content file for downloading by another data storage device; a second data storage device configured for distributing the content file; a third data storage device configured for distributing the content file; a data file comprising at least one data entry, a data entry in the data file being associated with the content file; and a user device connectable to the second data storage device for accessing the downloaded content file at the second data storage, the first data storage device being configured for pushing the data file to the second data storage device, the second data storage device being configured for initiating downloading of the content file if the data entry associated with the content file is present in the pushed data file and the content file is not stored at the second data storage device, and sharing downloaded data of the content file with the third data storage device by simultaneously uploading downloaded data of the content file to the third data storage device while downloading the content file from the first data storage device.

The system may further comprise a user device connectable to the second data storage device for accessing the downloaded content file at the second data storage,

The second data storage device may be configured to upload the downloaded content file to the user device.

The second data storage device may be configured to stream the downloaded content file for displaying or sound production at the user device.

The second data storage device may be configured to seed the downloaded content file for downloading by another data storage device.

The system may further comprise a licence key server comprising one or more licence keys for unlocking accessibility to the content of the content file, wherein the second data storage device allows the user to access the content file via the user device if a licence key associated with the content file is present at the second data storage device.

In the absence of the licence key at the second data storage device, the second data storage device may begin downloading of the licence key from the licence key server if a user account of the user comprise sufficient credits or has acquired allowance to download the licence key.

Each of the at least one data entry may comprise metadata about the content of a content file and the related tracker information.

The second data storage device may be configured to remove from the second data storage device a content file that has no associated data entry in the pushed data file.

Downloaded data of the content file may be distributed over the second data storage device, the third data storage device, and one or more separate data storage device using a RAID 5 type algorithm.

The distribution of the content file from the first data storage device to the second data storage device and the third data storage device may be based on Bittorrent protocol.

The second data storage device and the third data storage device may be parts of a single device.

The data file may further comprise filtering data indicating files to be deleted from the second data storage or held back from downloading to the second data storage.

In accordance with another aspect of the present invention, there is provided a method for file distribution, the method comprising: distributing a content file by seeding the content file at a first data storage device for downloading by another data storage device; pushing a data file comprising at least one data entry from the first data storage device to a second data storage device, a data entry in the data file being associated with a content file; initiating downloading of the content file to the second data storage device if the data entry associated with the content file is present in the pushed data file and the content file is not stored at the second data storage device; downloading the content file to the second data storage device; and sharing downloaded data of the content file at the second data storage device with a third data storage device by simultaneously uploading downloaded data of the content file from the second data storage device to the third data storage device while downloading the content file from the first data storage device.

Providing the user with access to the downloaded content file via the user device connected to the second data storage device may comprise downloading the downloaded content file to the user device to enable the user to access the content file via the user device.

Providing the user with access to the downloaded content file via the user device connected to the second data storage device may comprise downloading the downloaded content file to the user device to enable the user to access the content file via the user device.

Providing the user with access to the downloaded content file via the user device connected to the second data storage device may comprise streaming the downloaded content file to the user device for displaying or sound production at the user device.

The method may further comprise seeding the downloaded content file at the second data storage device for downloading by another data storage device.

The method may further comprise unlocking user accessibility to licensed content of the content file if a licence key associated with the licensed content is stored at the second data storage device.

The method may further comprise downloading the licence key from a licence key server to the second data storage device if the licence key is not stored at the second data storage device and when a credit value associated with a user account of the user is at a predetermined value.

The method may further comprise removing from the second data storage device a content file that has no associated data entry in the pushed data file.

The method may further comprise distributing downloaded data of the content file over the second data storage device, the third data storage device, and one or more other data storage device, using a RAID 5 type algorithm.

The method may further comprise utilising Bittorrent protocol in the steps of distributing the content file by seeding the content file at a first data storage device for downloading by another data storage device, downloading the content file to the second data storage device, and sharing downloaded data of the content file at the second data storage device with a third data storage device by simultaneously uploading downloaded data of the content file from the second data storage device to the third data storage device while downloading the content file from the first data storage device.

In accordance with yet another aspect of the present invention, there is provided a data storage device for file distribution, the data storage device comprising: a data storage medium for storing a content file that is distributed; a network interface for receiving a data file comprising at least one data entry pushed from a first data storage device distributing the content file by seeding the content file for downloading by the data storage device, a data entry in the data file being associated with the content file; and a processing unit for initiating the downloading of the content file through the network interface to the data storage medium if the data entry associated with the content file is present in the pushed data file and the content file is not stored in the data storage medium, wherein the processing unit is configured to share downloaded data of the content file in the data storage medium with a second data storage device by simultaneously uploading the downloaded data of the content file to the second data storage device while downloading the content file from the first data storage device, and the downloaded content file stored in the data storage medium is accessible by a user via a user device connectable to the data storage device, wherein the processing unit is further configured to distribute the downloaded content file by pushing to another data storage device a second data file comprising indication that the data storage device or yet another data storage device is a tracker or seeder for the content file.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1 is a schematic drawing of an example embodiment of the present invention.

FIG. 2 is a flowchart illustrating a method of operation of the example embodiment of the present invention.

FIG. 3 is a flowchart illustrating the method of operation of the example embodiment of the present invention.

FIG. 4 is a flowchart illustrating the method of operation of the example embodiment of the present invention.

FIG. 5 is a schematic drawing of a computer system of the example embodiment of the present invention.

### DETAILED DESCRIPTION

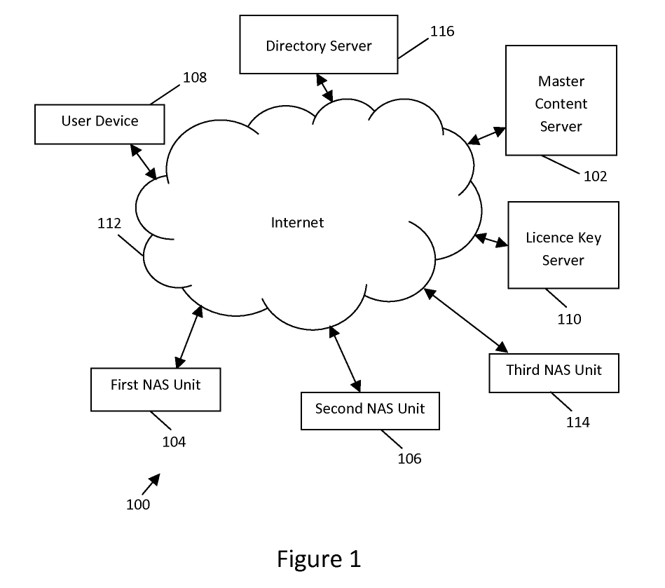

FIG. 1 illustrates a system 100 for file distribution according to an example embodiment of the present invention. There is provided a Master content server 102, a User device 108, a Licence key server 110 and a network of Network Attached Storage (NAS) devices, which comprises, in this embodiment, a first NAS unit 104, a second NAS unit 106 and a third NAS unit 114. The servers 102, 110, User device 108 and the first, second and third NAS units 104, 106, 114 respectively, are connected to the Internet 112. It is appreciated that more than three NAS units may be deployed in other example embodiments. There can also be more than one User device 108 in other example embodiments.

In the example embodiment, an NAS unit is essentially a self-contained computer connected to a network, with the purpose of supplying file-based data storage services to other devices on the network. It is appreciated that in other embodiments, a file server, a second Master content server, or other similar devices may be implemented in place of the one or more of the first, second and third NAS units 104, 106, 114 respectively.

The Master content server 102 and each of the first, second and third NAS units 104, 106, 114 respectively are installed with a Peer-to-Peer (P2P) file delivery mechanism. In the example embodiment, the P2P file delivery mechanism is Bittorrent.

The Master content server 102 functions as a central data storage device and distributor of digital content files. A digital content file could be a data, picture, video or audio file. The Master content server 102 distributes and initiates the distribution of content files by seeding them for downloading by the first, second and third NAS units 104, 106, 114 respectively.

The Master content server 102 also functions as a Bittorrent tracker besides fulfilling the role of a seeder (also known as a seed server). A seeder has a complete copy of the relevant content file and makes it available for downloading via Bittorrent. As a Bittorrent tracker, the Master content server 102 assists in the communication between peers (i.e., the first, second and third NAS units 104, 106, 114 respectively and the Master content server 102) using the Bittorrent protocol. Clients (i.e., the first, second and third NAS units 104, 106, 114 respectively) are required to communicate with the tracker to initiate downloads. Clients that have already begun downloading also communicate with the tracker periodically to negotiate with newer peers and, in this example embodiment, optionally provide statistics with regard to, for instance, number of seeders and downloaders (i.e. downloading peers).

By using Bittorrent, advantageously, each one of the first, second and third NAS units 104, 106, 114 respectively support the distribution of the content files, thereby eliminating the heavy bandwidth demands required of the Master content server in the case where it is implemented with the traditional file transfer methodology via a network.

Whenever a new content file is loaded in the Master content server 102, on the manual activation of a human administrator or by way of an automatic software activator, the Master content server 102 would push or send (Note that ‘push’ and ‘send’ are used interchangeably throughout this specification) a data file containing a data entry comprising downloading information of the new content file to all the first, second and third NAS units 104, 106, 114 respectively. The data file contains more than one data entry comprising previously downloaded and new content files. On receiving the data file, the first, second and third NAS units 104, 106, 114 respectively would begin to download and share the new content file via Bittorrent. Each data entry in the data file is equivalent to a torrent file. A torrent file contains metadata about the content files to be shared and about the tracker, e.g. the Master content server 102. Alternatively, in other example embodiments, the Master content server 102 could be configured to push the individual torrent files to the first, second and third NAS units 104, 106, 114 respectively instead of pushing a data file containing a list of data entries resembling torrent files.

The data file may further contain filtering data which indicate a list of content files associated with the data entries in the data file that are to be deleted and not to be downloaded by the NAS unit receiving it. In the example embodiment, on receiving the data file, the NAS units 104, 106, 114 would decipher the filtering data to determine the content files that are to be deleted or not to be downloaded and then execute as such. The filtering data may be configured to suit user preferences, to abide by licensing arrangements, or country laws. For instance, a user or owner of an NAS unit may pre-select a particular genre of digital content to be filtered out, certain digital contents may also be filtered out due to licence restrictions in certain countries, or because the content is disallowed in the countries. Alternatively, in another example embodiment, the filtering of content may be performed at the Master Content Server 102 prior to sending out the data file to each NAS unit, i.e. each data file sent to the NAS unit would already be filtered by the Master Content Server 102. In this case, the data file need not contain any filtering data since all the data entries would already be ascertained by the Master Content Server 102 as suitable for downloading by the specific NAS unit.

In the example embodiment, each of the first, second and third NAS units 104, 106, 114 respectively are associated with a group of user accounts. One user account may be associated with a few NAS units. Each of first, second and third NAS units 104, 106, 114 respectively provides data storage services for each user account in the group. The User device 108 belongs to an end user. Examples of what may constitute a User device 108 are network enabled desktop computers, laptop computers, mobile phones, personal digital assistants, media players, entertainment devices, and the like. An end user may have one or more user accounts.

In the example embodiment, the Master content server 102 and the Licence key server 110 belong to a Service Provider (or Content Provider). It is appreciated that in other example embodiments, one or more of the first, second and third NAS units 104, 106, 114 respectively may belong to the Service Provider. In the present embodiment, the first, second and third NAS units 104, 106, 114 respectively belong to individual private proprietors serving its own group of user accounts.

In the example embodiment, an end user can access from his/her User device 108 content files, which are associated with a user account of the end user and seeded at the Master content server 102 for downloading by the first NAS unit 104. End users may access content files stored at the first NAS unit 104 in two ways. One way is to download the content files directly from the first NAS unit 104 to the User device 108 via the Internet or via a direct connection between the first NAS unit 104 and the User device 108 (e.g. through a wire cable, telecommunication network, or wireless local area network). The downloaded content files would then be played back or executed on the User device 108. Another way to access the content files is to instruct the first NAS unit 104 to stream the content file through the Internet or through the direct connection for executing or direct playback (in the case of multimedia files) on the User device 108.

Prior to allowing an end user to access requested content files on the first NAS unit 104 via one of the two ways mentioned, the first NAS unit 104 will check whether a licence key associated with the content file is available. In the example embodiment, the licence key is stored and verified at the first NAS unit 104. If the licence key is not present, the first NAS unit 104 will check the user account associated with the end user to see if the user account has a subscription plan allowing the user to access the content file or whether the user has sufficient credits for the first NAS unit 104 to download the licence key from the Licence key server 110. If a subscription plan exists or sufficient credits are detected, the licence key will be downloaded from the Licence key server 110. If there is no subscription plan or insufficient credits, the end user will not be allowed to access the requested content files. Advantageously, this licence key checking procedure ensures that copyrighted material will not be illegally distributed to the end users.

Another advantage of the example embodiment is that the privacy of the end user can be protected as the end user accesses the content files on his/her User device 108 through a dedicated NAS unit, i.e. the first NAS unit 104. Accessing the first NAS unit 104 via the User device 108 would require going through a directory server 116, which requires user authentication from the User device 108 before access to the first NAS unit 104 is allowed. In this manner, the Internet Protocol (IP) address assigned to the User device 108 would be revealed only to the first NAS unit 104 but not to other end users. Further security measures can be taken at the first NAS unit 104 to ensure that the user IP addresses are not disclosed. It is noted that if the end user bypasses the first NAS unit 104 and directly downloads content files from the Master content server 102 to his/her User device 108 via a Bittorrent client program, the IP address may be undesirably revealed to other end users who are also downloading the same content files via a Bittorrent client program.

Furthermore, if the Master Content Server 102, the first, second and third NAS units 104, 106, 114 respectively are properly maintained and managed, the example embodiment can ensure that there will always be sufficient seeders, thus eliminating the problem in the present implementations of Bittorrent where most end users often have no intention to be seeders after a file has been completely downloaded. The problem with lack of seeders for less popular files and wilful withholding of a specific piece of data can also be eliminated.

Also, advantageously, the example embodiment provides numerous back-ups of the content files for the downloading or streaming to an end user's User device 108, as the content files are duplicated on numerous NAS units. Each user account may be associated with a main serving NAS unit and a few back-up NAS units. If the main serving NAS unit becomes faulty, which may be detected by the lack of requested response from the NAS unit, a back-up NAS unit may be deployed to provide the end user with the requested content file.

Moreover, by letting the Master content server 102 initiate the distribution of new content files, the example embodiment advantageously removes the need for end users to search for torrent files manually. The NAS units 104, 106, 114 will also always be up to date with the latest content files. End users can access the latest content files on their User devices (e.g. the User device 108) anytime by downloading the new content files, or streaming the new content files directly for displaying or sound production from the first, second and third NAS units 104, 106, 114 respectively.

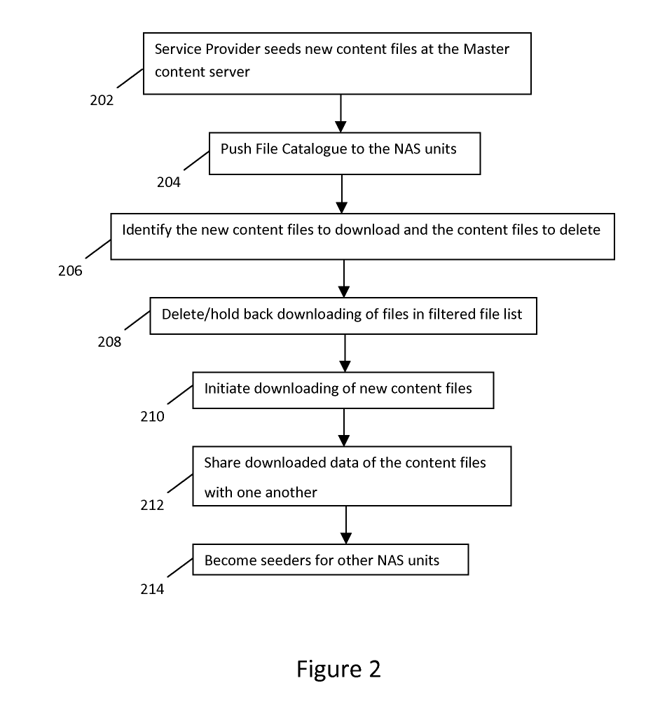

A method of operation of the example embodiment is described as follow with reference to FIGS. 1 and 2.

When new content files are available, the Service Provider seeds the new content files at the Master content server 102 for downloading and distribution by the first, second and third NAS units 104, 106, 114 respectively at step 202.

At step 204, a data file, also herein known as a File Catalogue, which contains a list of torrent files for the new content files and filtering data, in this case in the form of a filtered file list, is pushed to one or more registered NAS units. The filtered file list may be different for each NAS unit. All the files listed in the filtered file list are to be deleted or are not to be downloaded by the NAS unit. In the example embodiment, the File Catalogue is pushed to the first, second and third NAS units 104, 106, 114 respectively.

A registered NAS unit is one which has been registered with the Service Provider and has its network location details (e.g. IP address) recorded in a “pushed to” list stored and updated at the Master content server 102. The “pushed to” list is referred by the Master content server 102 to determine which NAS unit receives the pushed File Catalogue. Some criteria for registering an NAS unit with the Service Provider may be, for example, good protection for the privacy of users, good maintenance and management of the NAS unit to ensure that the NAS units would become seeders to aid in the distribution of content files for newly added/registered NAS units or existing registered NAS units.

At step 206, the individual NAS units 104, 106, 114 read the pushed File Catalogue and perform a check to compare the content files listed in the File Catalogue against the content files already in the data storage of the first, second and third NAS units 104, 106, 114 respectively to identify the new content files to download to their data storage and to identify the content files to delete away from their data storage. New content files are identified based on its existence in the File Catalogue and absence in the individual data storages of the first, second and third NAS units 104, 106, 114 respectively. Content files to be deleted from the data storages of the first, second and third NAS units 104, 106, 114 respectively are identified based on its absence in the File Catalogue. Basically, the idea is to ensure that the data storages of the first, second and third NAS units 104, 106, 114 respectively contain only the content files listed in the File Catalogue.

Advantageously, step 206 makes it easy to instruct the NAS units to add or delete files. This step also provides for the instance to make available a content file for user access for a limited time period only. For example, at the start of the limited time period, a File Catalogue listing a new content file is pushed to the NAS unit, thereby instructing the NAS unit to download the new content file. At the end of the time period, a File Catalogue containing a listing with the same content file removed is pushed to the NAS unit, thereby instructing the NAS unit to delete the same content file it has previously downloaded.

At step 208, the NAS units 104, 106, 114 read the filtered file list in the pushed File Catalogue and delete or hold back the downloading of the files listed in the filtered file list.

At step 210, the first, second and third NAS units 104, 106, 114 respectively initiate the downloading of new content files seeded at the Master content server 102 after they determine which content files to download or delete at step 206. It is noted that the content files may be downloaded from network servers/devices seeding the content files other than from the Master content server 102.

At step 212, the first, second and third NAS units 104, 106, 114 respectively share downloaded data of the content files with one another in accordance with the Bittorrent protocol, i.e. by simultaneously uploading downloaded data of the content file to one another while downloading the new content files. During the downloading process, according to the Bittorrent protocol, each of the first, second and third NAS units 104, 106, 114 respectively, would request from one another and from the Master content server 102 the missing pieces of the data of the content files, which they do not have. The NAS units and the Master content server 102 having the missing pieces would upload them to the NAS units requesting for the missing pieces. To avoid duplicates, an NAS unit would not upload or send the same piece of data twice to the same NAS unit, and an NAS unit would only request for the data piece of the content file, which it has not already downloaded.

At step 214, the first, second and third NAS units 104, 106, 114 respectively individually become the seeders for other registered NAS units seeking to download the new content files via Bittorrent when the downloading of the content files has completed at the individual first, second and third NAS units 104, 106, 114.

It is appreciated that in other example embodiments, the Master content server 102 may push a first File Catalogue containing torrent files of new content files to one or more pre-specified NAS units. After the pre-specified NAS unit(s) completed the downloading of the new content files seeded by the Master content server 102, these NAS unit(s) may be configured to generate and send a second File Catalogue to one or more other NAS units, which are not pre-specified to receive the first File Catalogue sent out by the Master content server 102. The NAS units sending out the second File Catalogue may include or update the second File Catalogue with information indicating the Master content server 102, itself and other NAS units, which have also successfully downloaded the new content files, as trackers and/or seeders to aid the NAS units receiving the second File Catalogue in the downloading and distribution of the new content files. In the similar chain-like manner, on the completion of the downloading of the new content files, the NAS units that received the second File Catalogues may generate and send third File Catalogues, to more NAS units, which do not have the new content files and are specified to download the new content files. The chain may carry on until all the NAS units specified to download the new content files have completed their downloading. In this manner, advantageously, the outgoing bandwidth required of the Master Content Server 102 and the file sharing NAS units is much reduced. The NAS units can also get their data storage updated with the latest content files fast and orderly if there is a massive deployment of NAS units.

In the example embodiment, the digital content, including text, picture, video and audio, of the content files is protected by Digital Rights Management (DRM). The digital content may be a subset of the full content of the content file that is available on the Master content server 102. The DRM protected media content downloaded to the first, second and third NAS units 104, 106, 114 respectively may not contain the licence key for the playback of the digital content. As such, in order for an end user to be able to playback the licensed content files, a licence key must be acquired from the Licence key server 110. A transaction fee or subscription fee may be paid by the end user to acquire sufficient credits to access the Licence key server 110 to retrieve the specific licence key. For instance, the payment of a one off transaction fee can purchase credits linked to the end user's user account for redeeming the specific licence key. The periodic payment of a subscription fee would add a specific amount of credits to the user account periodically. The amount of credits required to access the Licence key server 100 to redeem the specific licence key may vary according to, for instance, the popularity of the content file associated with the licence key. In addition, on payment of the subscription fee, instead of addition of credits to the user account periodically, it could be that a subscription plan is acquired and the plan provides the user with unlimited or limited rights to access, for instance, a particular video/music/software database supplying a selection/genre of videos/songs/software.

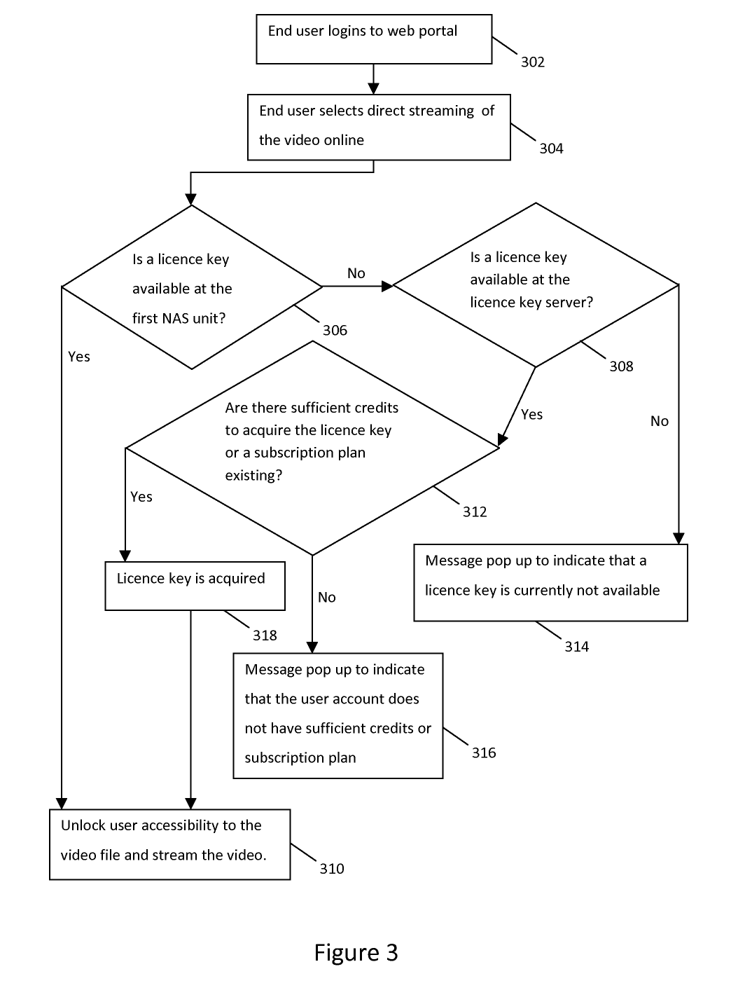

FIG. 3 illustrates a scenario in the operation of the example embodiment where an end user requests to playback a video file stored at an NAS unit on his/her User device 108. The following description relating to FIG. 3 also makes reference to FIG. 1.

At step 302, the end user logins to a web portal hosted by the Service Provider with his/her registered user account using a web browser on his/her User device 108. After user authentication is successful and the user has login, the end user browses a video catalogue at the web portal, which contains a list of all the video files stored at the NAS unit associated with its user account, which is, for this illustration, the first NAS unit 104. Each video featured in the video catalogue has an accompanying indicator indicating whether the video file is immediately playable, pending download, has already downloaded completely, or is still awaiting release to the public. The web portal further contains a window displaying the remaining amount of credits, which is linked to the user account.

There may be available a download button adjacent to the featured video in the video catalogue for downloading the video file to the User device 108 if the video file is already completely downloaded to the first NAS unit 104. Furthermore, there is provided a window adjacent to the featured video in the video catalogue showing the amount of credits required to acquire a licence key for downloading or for direct online streaming of the video.

At step 304, the end user selects to play a video indicated as immediately playable by directly streaming the video online.

At step 306, the first NAS unit 104 associated with the user account checks if the licence to playback the selected video file by direct online streaming is available at the first NAS unit 104.

If the licence key is available at the first NAS unit 104, user accessibility to the video file is unlocked and the video file is streamed from the first NAS unit 104 for viewing on the web portal at step 310.

If the licence is not available at the first NAS unit 104, the first NAS unit 104 will check whether the licence to playback the selected video file by online streaming is available at the Licence key server 110 at step 308.

If the licence is not available at the Licence key server 110, a message will pop up at the web portal to indicate that a licence key is currently not available at step 314.

If the licence is available at the Licence key server 110, the NAS unit will perform a check to verify whether there are sufficient credits presently linked to the user account for the end user to access the Licence key server 110 to acquire the licence key for playing the video at step 312. At the same time, the NAS unit will check whether the user has acquired allowance to download the licence key, e.g. whether the user has acquired any subscription plan allowing the user to access the video. As mentioned previously, credits can be purchased through a one off transaction fee or acquired periodically through payment of subscription fees.

If there are insufficient credits to acquire a licence key or a subscription plan has not been acquired, a message will pop up at the web portal to indicate that the user account does not have sufficient credits to acquire the licence key or a subscription plan for the playback of the video at step 316.

If there are sufficient credits to acquire the licence key or a subscription plan exists, the licence key would be acquired, i.e. downloaded from the Licence key server 110 to the first NAS unit 104, at step 318. Thereafter, user accessibility to the video file is unlocked and the video file is streamed from the first NAS unit 104 for viewing on the web portal at step 310.

It is appreciated that the same steps 306 to 318 would apply if downloading of the video file is selected instead of playing back the video through online streaming.

Steps 302 to 318 can be similarly applied for file types other than video files, such as, executable text files (e.g. ebooks in .pdf/.doc format), picture files, software applications and audio files.

It is further appreciated that in other embodiments, the video can be played back on a separate display device linked to an audio reproduction device that are connected to the first NAS unit 104 instead of being played back on the User device 108. For instance, instead of selecting the video for displaying on the User device 108, the video can be selected by the end user at the web portal to be played back on a High Definition Display in High Definition (HD) format, on a normal display in Standard Definition (SD) format, or on other displays in other display formats. The High Definition display, normal display or other display equipment are connected to the first NAS unit 104 via a High-Definition Multimedia Interface (HDMI), a Standard Definition interface or an appropriate video display interface connection respectively. In the case of audio files, the audio file may be played back on a separate audio reproduction device that is connected (via Internet or via direct wired or wireless connection) to the first NAS unit 104.

It is appreciated that in another example embodiment, the data file or File Catalogue described previously with reference to FIGS. 1 and 2 may only contain the data entries of new content files required to be downloaded by the first, second and third NAS units 104, 106, 114 respectively. In this case, the absence of a data entry associated with a particular content file in the data file or File Catalogue would not be read as a command to delete the copy of the content file already stored on the first, second and third NAS units 104, 106, 114 respectively. Deletion of content files stored on the first, second and third NAS units 104, 106, 114 respectively can be instructed separately via manual user controls at the first, second and third NAS units 104, 106, 114 respectively. In this embodiment, the user can decide when to delete what content files residing in the first, second and third NAS units 104, 106, 114 respectively.

It is further appreciated that in another example embodiment, the data of the content files may be distributed over a pre-specified cluster of NAS units comprising three or more NAS units using a “Redundant Arrays of Inexpensive Disks (RAID) 5” type algorithm. In this case, the RAID 5 algorithm would stripe both data and parity information of the content files to be downloaded to the NAS units across all the NAS units in the cluster. Utilising RAID 5 replaces the conventional dedicated parity data storage for a distributed parity algorithm, which writes data and parity blocks across all the NAS units in the cluster in an array-like manner. Advantageously, write performance (i.e. downloading of data to the NAS units) would be improved and there is better parallelism, in terms of data distribution of the content files, in the multiple-transaction environment such as that in the example embodiment described.

It is appreciated that in another example embodiment, two or more of the NAS units (i.e. 104, 106 and 114) described previously with reference to FIGS. 1, 2 and 3 may be parts of a single device. For instance, each of the NAS unit described may be a hard disk drive connected to a single processor unit or server unit.

Each of the NAS unit described may also be a virtual device residing on a single data storage device, e.g. a partitioned virtual drive on a hard disk drive.

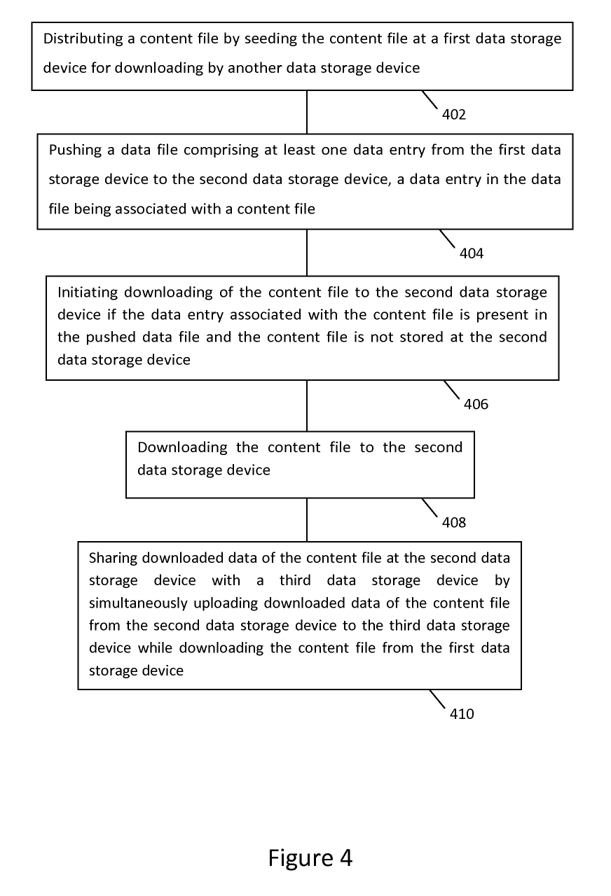

With reference to FIG. 4, generally, the steps of the method of operation of the example embodiment described with reference to FIGS. 1 to 3 are as follow.

At step 402, distributing a content file by seeding the content file at a first data storage device (e.g. the Master content server 102) for downloading by another data storage device (e.g. the first NAS unit 104, second NAS unit 106, or the third NAS unit 114).

At step 404, pushing a data file comprising at least one data entry from the first data storage device to the second data storage device, a data entry in the data file being associated with a content file.

At step 406, initiating downloading of the content file to the second data storage device if the data entry associated with the content file is present in the pushed data file and the content file is not stored at the second data storage device;

At step 408, downloading the content file to the second data storage device;

At step 410, sharing downloaded data of the content file at the second data storage device with a third data storage device (e.g. the first NAS unit 104, second NAS unit 106, or the third NAS unit 114) by simultaneously uploading downloaded data of the content file from the second data storage device to the third data storage device while downloading the content file from the first data storage device.

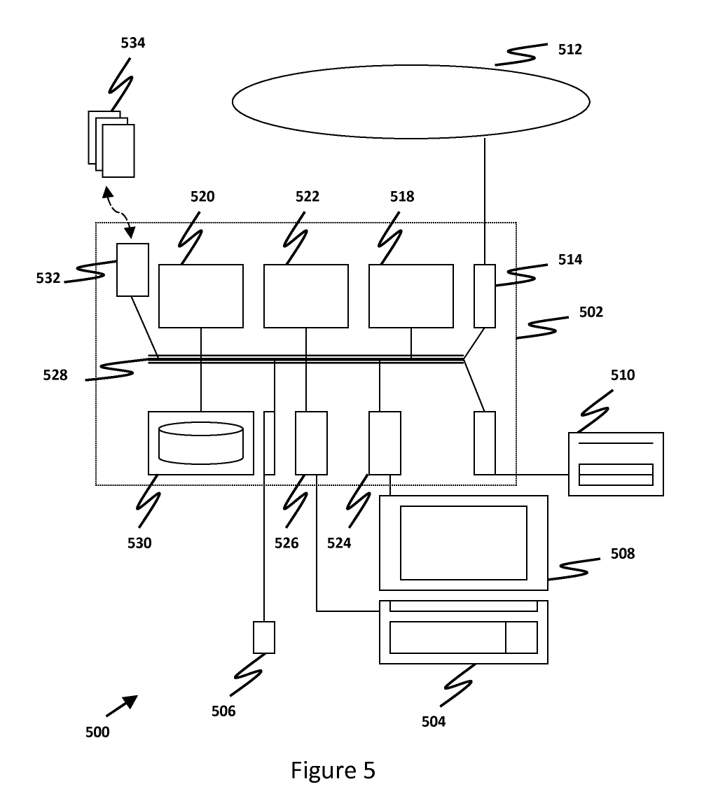

The Master content server 102, the first, second and third NAS units 104, 106, 114 respectively and User device 108 of the example embodiment described earlier with reference to FIG. 1 individually can be implemented on a computer system 500, schematically shown in FIG. 5. There may be provided software, such as one or more computer programs being executed within the computer system 500, and instructing the computer system 500 to conduct some methods of the example embodiment, including the instructions for the web applications on a web portal for managing user accounts, for the Bittorrent file sharing processes, for creation, writing and reading of the File Catalogue, for enabling wired or wireless device communications (where applicable), etc.

The computer system 500 comprises a computer module 502 (also known as a processing unit) for processing the one or more computer programs, and may include input modules such as a keyboard 504, a mouse 506, a plurality of output devices such as a display 508, and printer 510 to facilitate interaction with the computer system 500.

The computer module 502 is connected to a computer network 512 via a suitable transceiver device 514 (i.e. a network interface), to enable access to e.g. the Internet (112 in FIG. 1) or other network systems such as a wired Local Area Network (LAN) or Wide Area Network (WAN). The computer module 502 may be connected to one or more external wireless communication enabled devices 534 (e.g. User device 508) via a suitable wireless transceiver device 532 e.g. a WiFi transceiver, Bluetooth module, Mobile telecommunication transceiver suitable for Global System for Mobile Communication (GSM), 3G, 3.5G, 4G telecommunication systems, and the like.

The computer module 502 in the example includes a processor 518, a Random Access Memory (RAM) 520 and a Read Only Memory (ROM) 522. The computer module 502 also includes a number of Input/Output (I/O) interfaces, for example I/O interface 524 to the display 508, and I/O interface 526 to the keyboard 504.

The components of the computer module 502 typically communicate via an interconnected bus 528 and in a manner known to the person skilled in the relevant art.

The computer programs may include one or more software applications for e.g. web accessibility/development/maintenance, operating the computer system 500 (i.e. operating system), network security, file accessibility/management/maintenance/editing, database management/maintenance/editing, which are applications typically equipped on a web server, or a desktop or portable computer. The computer programs may be supplied to the user of the computer system 500 encoded on a data storage medium such as a CD-ROM, on a flash memory carrier or a Hard Disk Drive, and are to be read using a corresponding data storage medium drive of a data storage device 530. Such application programs may also be downloaded from the computer network 512. The application programs are read and controlled in its execution by the processor 518. Intermediate storage of program data may be accomplished using RAM 520.

Furthermore, one or more of the steps of the computer programs may be performed in parallel rather than sequentially. One or more of the computer programs may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the WLAN system. The computer program when loaded and executed on such a general-purpose computer effectively results in an apparatus that implements the steps of the methods of the example embodiment.

Many modifications and other embodiments can be made to the system and its method by those skilled in the art having the understanding of the above described disclosure together with the drawings. Therefore, it is to be understood that the device and its utility is not to be limited to the above description contained herein only, and that possible modifications are to be included in the claims of the disclosure.

1. A system for file distribution, the system comprising:
a first data storage device for distributing a content file by seeding the content file for downloading by another data storage device;
a second data storage device configured for distributing the content file;
a third data storage device configured for distributing the content file; and
a data file comprising at least one data entry, a data entry in the data file being associated with the content file,
the first data storage device being configured for pushing the data file to the second data storage device,
the second data storage device being configured for
initiating downloading of the content file if the data entry associated with the content file is present in the pushed data file and the content file is not stored at the second data storage device, and
sharing downloaded data of the content file with the third data storage device by simultaneously uploading downloaded data of the content file to the third data storage device while downloading the content file from the first data storage device.

2. The system as claimed in claim 1, the system further comprising:
a user device connectable to the second data storage device for accessing the downloaded content file at the second data storage,

3. The system as claimed in claim 2, wherein the second data storage device is configured to upload the downloaded content file to the user device.

4. The system as claimed in claim 2, wherein the second data storage device is configured to stream the downloaded content file for displaying or sound production at the user device.

5. The system as claimed in claim 1, wherein the second data storage device is configured to seed the downloaded content file for downloading by another data storage device.

6. The system as claimed in claim 1, the system further comprising:
a licence key server comprising one or more licence keys for unlocking accessibility to the content of the content file, wherein the second data storage device allows the user to access the content file via the user device if a licence key associated with the content file is present at the second data storage device.

7. The system as claimed in claim 6, wherein in the absence of the licence key at the second data storage device, the second data storage device begins downloading of the licence key from the licence key server if a user account of the user comprise sufficient credits or has acquired allowance to download the licence key.

8. The system as claimed in claim 1, wherein each of the at least one data entry comprising:
metadata about the content of a content file and the related tracker information.

9. The system as claimed in claim 1, wherein the second data storage device is configured to remove from the second data storage device a content file that has no associated data entry in the pushed data file.

10. The system as claimed in claim 1, wherein downloaded data of the content file is distributed over the second data storage device, the third data storage device, and one or more separate data storage device using a RAID 5 type algorithm.

11. The system as claimed in claim 1, wherein the distribution of the content file from the first data storage device to the second data storage device and the third data storage device is based on Bittorrent protocol.

12. The system as claimed in claim 1, wherein the second data storage device and the third data storage device are parts of a single device.

13. The system as claimed in claim 1, wherein the data file further comprising filtering data indicating files to be deleted from the second data storage or held back from downloading to the second data storage.

14. A method for file distribution, the method comprising:
distributing a content file by seeding the content file at a first data storage device for downloading by another data storage device;
pushing a data file comprising at least one data entry from the first data storage device to a second data storage device, a data entry in the data file being associated with a content file;
initiating downloading of the content file to the second data storage device if the data entry associated with the content file is present in the pushed data file and the content file is not stored at the second data storage device;
downloading the content file to the second data storage device; and
sharing downloaded data of the content file at the second data storage device with a third data storage device by simultaneously uploading downloaded data of the content file from the second data storage device to the third data storage device while downloading the content file from the first data storage device.

15. The method as claimed in claim 14, the method further comprising:
providing a user with access to the downloaded content file via a user device connected to the second data storage device.

16. The method as claimed in claim 15, wherein providing the user with access to the downloaded content file via the user device connected to the second data storage device comprises:
downloading the downloaded content file to the user device to enable the user to access the content file via the user device.

17. The method as claimed in claim 15, wherein providing the user with access to the downloaded content file via the user device connected to the second data storage device comprises:
streaming the downloaded content file to the user device for displaying or sound production at the user device.

18. The method as claimed in claim 14, the method further comprising:
seeding the downloaded content file at the second data storage device for downloading by another data storage device.

19. The method as claimed in claim 14, the method further comprising:
unlocking user accessibility to licensed content of the content file if a licence key associated with the licensed content is stored at the second data storage device.

20. The method as claimed in claim 19, the method further comprising:
downloading the licence key from a licence key server to the second data storage device if the licence key is not stored at the second data storage device and when a credit value associated with a user account of the user is at a predetermined value.

21. The method as claimed in claim 14, the method further comprising:
removing from the second data storage device a content file that has no associated data entry in the pushed data file.

22. The method as claimed in claim 14, the method further comprising:
distributing downloaded data of the content file over the second data storage device, the third data storage device, and one or more other data storage device, using a RAID 5 type algorithm.

23. The method as claimed in claim 14, the method further comprising:
utilising Bittorrent protocol in the steps of distributing the content file by seeding the content file at a first data storage device for downloading by another data storage device, downloading the content file to the second data storage device, and sharing downloaded data of the content file at the second data storage device with a third data storage device by simultaneously uploading downloaded data of the content file from the second data storage device to the third data storage device while downloading the content file from the first data storage device.

24. A data storage device for file distribution, the data storage device comprising:
a data storage medium for storing a content file that is distributed;
a network interface for receiving a data file comprising at least one data entry pushed from a first data storage device distributing the content file by seeding the content file for downloading by the data storage device, a data entry in the data file being associated with the content file; and
a processing unit for initiating the downloading of the content file through the network interface to the data storage medium if the data entry associated with the content file is present in the pushed data file and the content file is not stored in the data storage medium,
wherein the processing unit is configured to share downloaded data of the content file in the data storage medium with a second data storage device by simultaneously uploading the downloaded data of the content file to the second data storage device while downloading the content file from the first data storage device, and
the downloaded content file stored in the data storage medium is accessible by a user via a user device connectable to the data storage device
wherein the processing unit is further configured to distribute the downloaded content file by pushing to another data storage device a second data file comprising indication that the data storage device or yet another data storage device is a tracker or seeder for the content file.
